(19) United States
(12) Patent Application Publication
(10) Pub. No.: US 2008/0143269 A1
(43) Pub. Date: Jun. 19, 2008

(54) DRIVING METHOD AND CIRCUIT FOR FLUORESCENT LAMP

(75) Inventors: Chih-Shun Lee, Taipei City (TW); Chien-Pang Hung, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: BEYOND INNOVATION TECHNOLOGY CO., LTD., Taipei City (TW)

(21) Appl. No.: 11/693,715

(22) Filed: Mar. 30, 2007

(30) Foreign Application Priority Data
Dec. 14, 2006 (TW) 95146855

(51) Int. Cl. H05B 37/02

(52) U.S. Cl. 315/219

(57) ABSTRACT

A driving method for a fluorescent lamp is provided. A driving signal for driving the fluorescent lamp is generated, and an operating current of the fluorescent lamp is detected. The frequency of the driving signal is adjusted when the operating current of the fluorescent lamp reaches a first predetermined value. Besides, whether or not the operating current of the fluorescent lamp reaches a second predetermined value is detected in order to decide whether to stop generating the driving signal or not, wherein the second predetermined value is greater than the first predetermined value.

### CROSS-REFERENCE TO RELATED APPLICATION

This application claims the priority benefit of Taiwan application serial no. 95146855, filed Dec. 14, 2006. All disclosure of the Taiwan application is incorporated herein by reference.

### BACKGROUND OF THE INVENTION

1. Field of the Invention

The present invention relates to a driving method and a driving circuit. More particularly, the present invention relates to a driving method and a driving circuit for a fluorescent lamp.

2. Description of Related Art

Liquid crystal display (LCD) has replaced cathode ray lamp (CRT) display to become the mainstream in the market due to its advantageous characteristics such as low power consumption, no radiation, and low electromagnetic interference. A LCD includes a LCD panel and a backlight module, wherein the backlight module is disposed for providing a light source required by the LCD panel since the LCD panel itself does not emit light, so that the LCD panel can display images.

Generally speaking, the light source used by the backlight module is usually cold cathode fluorescent lamp (CCFL). FIG. 1 illustrates the I-V curve of CCFL. Referring to FIG. 1, curve 101 illustrates the variation of the operating voltage of the CCFL along lamp current according to the characteristics of the CCFL. A large driving voltage has to be supplied to the CCFL for striking the CCFL. Thus, the kick-off voltage of the CCFL is V₁, and the operating voltage of the CCFL is reduced to V₂ after the CCFL is struck. The Voltage V_{Lamp} of the CCFL is related to the input voltage Vᵢₙ, the duty cycle D, the quality factor Q, and the turn ratio N of the transformer and which is expressed as V_{Lamp}=Vᵢₙ*D*Q*N.

The quality factor Q is the measurement of reactive power consumption in a resonance system, and the larger the quality factor Q is, the higher the reactive power consumption is. The resonant features of the resonance system are greatly related to the quality factor Q when the system is driven. The resonance system has higher voltage gain when driven close to its natural frequency, and the natural frequency of a resonance system having large quality factor Q has resonance of larger gain than that of a resonance system having smaller quality factor Q.

FIG. 2 illustrates a curve of the frequency response characteristic of a conventional driving circuit. Referring to FIG. 2, curve 201 denotes the frequency response characteristic while the quality factor Q has value 3, and the natural frequency thereof is f₁. The frequency of the driving current is usually adjusted to f₂ (close to the natural frequency thereof) for driving the CCFL. Curve 202 denotes the frequency response characteristic while the quality factor Q has value 1, and the natural frequency thereof is f₃. The frequency of the driving current is adjusted to f₃ after the CCFL is struck so as to provide a normal operating voltage to the CCFL.

The CCFL is affected by stray capacitors while detecting the state of the fluorescent lamp to determine whether or not to convert the frequency of the resonance system, which makes the detected current of the CCFL to be incorrect. As shown in FIG. 3, a stray capacitor 302 exists between the CCFL 101 and the metal housing, thus, the impedance X_{c} of the capacitor is related to the frequency f and the capacitance C, namely, X_{c}=1/(2πfC). While the CCFL is just started, a driving voltage of high frequency is used for driving the CCFL thus, the impedance X_{c} of the stray capacitor 302 is reduced and part of the current passes through the stray capacitor 302. Such a phenomenon becomes obvious when a large liquid crystal display (LCD) panel is used, and the more stray capacitor are, the larger the difference between the detected current of the CCFL and the actual current is, which causes the control device in the start-up driving circuit to mistakenly determine that the fluorescent lamp has not been struck or even causes incorrect operation of a protection apparatus for turning off the CCFL.

Previously, to resolve the problem of leakage current caused by stray capacitor, an upper limit of the frequency of the driving voltage is set so that leakage current caused by high driving voltage is prevented and the difference of the detected current of the CCFL and the actual current is reduced. However, with this method, the CCFL may not be stuck due to insufficient driving voltage. Besides, the temperature of the transformer in the driving circuit will be increased if the turn ratio N of the transformer in the driving circuit is increased for increasing the driving voltage.

Presently the most common driving method for CCFL is as following. A high-frequency driving voltage is provided for driving a CCFL while the CCFL is being struck. After the CCFL is struck and the operation thereof has been stabilized, a detection voltage (for example, 1.3V) corresponding to the current passing through the CCFL is generated. Generally speaking, it is determined that the CCFL is not struck if the voltage of the detection signal is lower than 1.3V, and the high frequency of the driving voltage is maintained for driving the CCFL; otherwise, if the voltage of the detection signal is greater than 1.3V, which means the CCFL has been struck successfully, the frequency of the driving voltage is adjusted so as to provide a normal operating voltage to the CCFL. After some time, whether or not to start up a protection function for the CCFL is determined based on the detection signal, and if the detection signal is lower than 1.3V, a protection apparatus is started to turn off the CCFL.

However, if the CCFL has been struck successfully but the voltage of the detection signal is lower than 1.3V due to large leakage current of stray capacitors, the CCFL which is in the striking status would be accidentally turned off due to the protection apparatus being started up; which may cause the LCD panel not being able to display.

Accordingly, how to resolve the foregoing problems is one of today's most important subjects.

### SUMMARY OF THE INVENTION

Accordingly, the present invention is directed to a driving method for a fluorescent lamp, wherein the frequency of a driving signal is timely reduced by detecting the level of a operating current of the fluorescent lamp, so that large leakage current in the fluorescent lamp caused by constantly driving the fluorescent lamp with the driving signal of high frequency is prevented. The operating current of the fluorescent lamp is then detected after a predetermined time in order to determine whether or not the fluorescent lamp is activated properly and determine whether or not to stop generating the driving signal for protecting the fluorescent lamp. Accordingly incorrect operation for protecting the fluorescent lamp caused by leakage current is prevented.

According to another aspect of the present invention, a driving method for a fluorescent lamp is provided, wherein the timing for reducing the frequency of a driving signal is determined by detecting an operating parameter of the fluorescent lamp, so that incorrect operation for protecting the fluorescent lamp due to leakage current can be prevented After a predetermined time, whether or not the fluorescent lamp has been activated properly is determined by detecting the operating parameter of the fluorescent lamp in consideration of noise interference, so that whether to stop generating the driving signal can be determined timely in order to protect the fluorescent lamp and to prevent incorrect operation for protecting the fluorescent lamp caused by noise interference.

According to yet another aspect of the present invention, a driving circuit for a fluorescent lamp is provided, wherein a driving signal is generated for driving the fluorescent lamp under the control of a control signal, and an operating parameter of the fluorescent lamp is detected for adjusting the frequency of the driving signal. After a predetermined time, the operating parameter of the fluorescent lamp is detected in order to determine whether or not the fluorescent lamp has been activated properly and determine whether or not to stop generating the driving signal so, as to protect the fluorescent lamp and to prevent incorrect operation for protecting the fluorescent lamp caused by leakage current from being started.

The present invention provides a driving method suitable for driving a fluorescent lamp. According to the driving method, a driving signal is generated for driving the fluorescent lamp, and an operating current of the fluorescent lamp is detected. The frequency of the driving signal is adjusted when the operating current of the fluorescent lamp achieves a first predetermined value. Moreover, whether or not the operating current of the fluorescent lamp is smaller than a second predetermined value is determined to decide whether to stop generating the driving signal or not, wherein the second predetermined value is greater than the first predetermined value.

According to an exemplary embodiment of the present invention, the driving method for fluorescent lamp further includes generating a first counting value and determining whether or not the operating current of the fluorescent lamp is smaller than the second predetermined value when the first counting value achieves a first predetermined counting value.

Moreover, according to the driving method for fluorescent lamp, the driving signal is generated when the detected operating current of the fluorescent lamp is greater than or equal to the second predetermined value, and the driving signal is stopped being generated when the detected operating current of the fluorescent lamp is smaller than the second predetermined value.

Furthermore, according to the driving method for fluorescent lamp, in the step of stopping generating the driving signal when the operating current is smaller than the second predetermined value, a second counting value is further generated and the driving signal is stopped being generated when the second counting value achieves a second predetermined counting value and the operating current is smaller than the second predetermined value.

According to an exemplary embodiment of the present invention, the driving method for fluorescent lamp further includes: the driving signal being a pulse width modulation (PWM) signal having a first frequency when the operating current has not achieved the first predetermined value, and the driving signal being a PWM signal having a second frequency when the operating current achieves the first predetermined value, wherein the first frequency is higher than the second frequency.

The present invention further provides a driving method for a fluorescent lamp. According to the driving method, a driving signal is generated for driving the fluorescent lamp and an operating parameter of the fluorescent lamp is detected. The frequency of the driving signal is adjusted when the operating parameter of the fluorescent lamp achieves a first predetermined value. After a predetermined time, whether or not the operating parameter is smaller than a second predetermined value is determined, wherein the driving signal is stopped being generated when the operating parameter is smaller than the second predetermined value, and the driving signal is further generated when the operating parameter is greater or equal to the second predetermined value.

The present invention further provides a driving circuit for a fluorescent lamp. The driving circuit includes a power conversion unit, a detection module, and a control unit. The power conversion unit generates a driving signal for driving the fluorescent lamp. The detection module detects an operating parameter of the fluorescent lamp. The control unit controls the power conversion unit to drive the fluorescent lamp. The control unit also receives the operating parameter. The control unit adjusts the frequency of the driving signal when the operating parameter achieves a first predetermined value, and after a first predetermined time, the control units determines whether or not the operating parameter is smaller than a second predetermined value. The control units controls the power conversion unit to stop generating the driving signal when the operating parameter is smaller than the second predetermined value after the first predetermined time.

According to the present invention, the frequency of the driving signal is timely adjusted according to a operating current (or operating parameter) of the fluorescent lamp in order to avoid constantly providing a high-frequency driving signal for driving the fluorescent lamp and to prevent incorrect operation for protecting the fluorescent lamp caused by overlarge leakage current from being started. After a predetermined time, the operating current (or operating parameter) of the fluorescent lamp is detected and noise interference is considered in order to determine whether or not the fluorescent lamp has been struck properly and to determine whether to provide the driving signal to the fluorescent lamp continuously or stop generating the driving signal so as to protect the fluorescent lamp. As described above, whether or not the fluorescent lamp has been struck can be determined correctly, and incorrect operation for protecting the fluorescent lamp caused by leakage current and noise can be prevented. A driving circuit which implements the driving method described above is also provided in the present invention.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates the I-V curve of a conventional cold cathode fluorescent lamp (CCFL).

FIG. 2 illustrates a curve of the frequency response characteristic of a conventional driving circuit.

FIG. 3 illustrates a conventional cold cathode fluorescent lamp and stray capacitors.

FIG. 4A is a block diagram of a driving circuit for a fluorescent lamp according to an exemplary embodiment of the present invention.

FIG. 4B is a circuit diagram of a driving circuit for a fluorescent lamp according to an exemplary embodiment of the present invention.

FIG. 5 is a timing diagram illustrating the operation of a driving circuit for a fluorescent lamp according to an exemplary embodiment of the present invention.

FIG. 6 illustrates a frequency conversion circuit according to an exemplary embodiment of the present invention.

FIG. 7 is a flowchart illustrating a driving method for a fluorescent lamp according to an exemplary embodiment of the present invention.

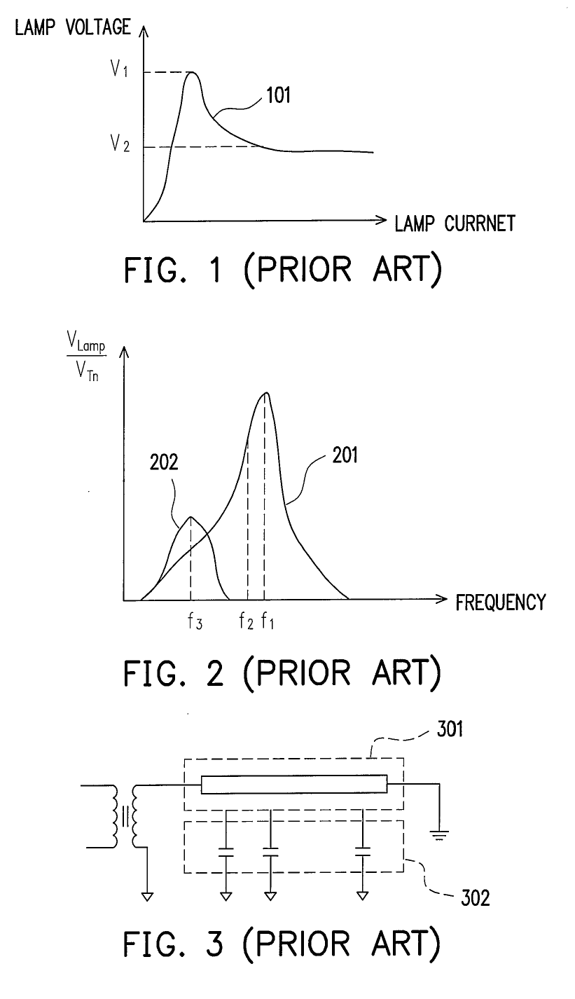

### DESCRIPTION OF EMBODIMENTS

It is assumed that the fluorescent lamp in the present embodiment is a cold cathode fluorescent lamp (CCFL); however, the present invention is not limited thereto, and those having ordinary knowledge in the art should be able to apply the driving method and circuit in the present invention to other fluorescent lamps.

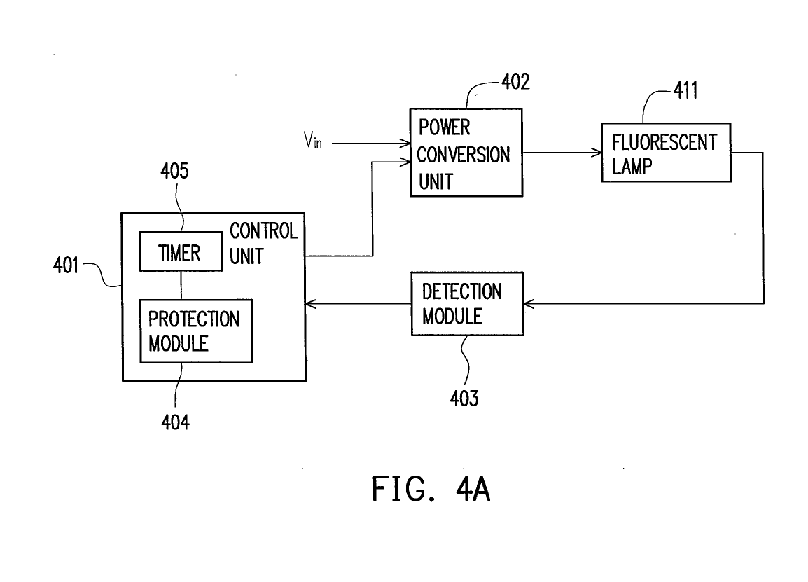

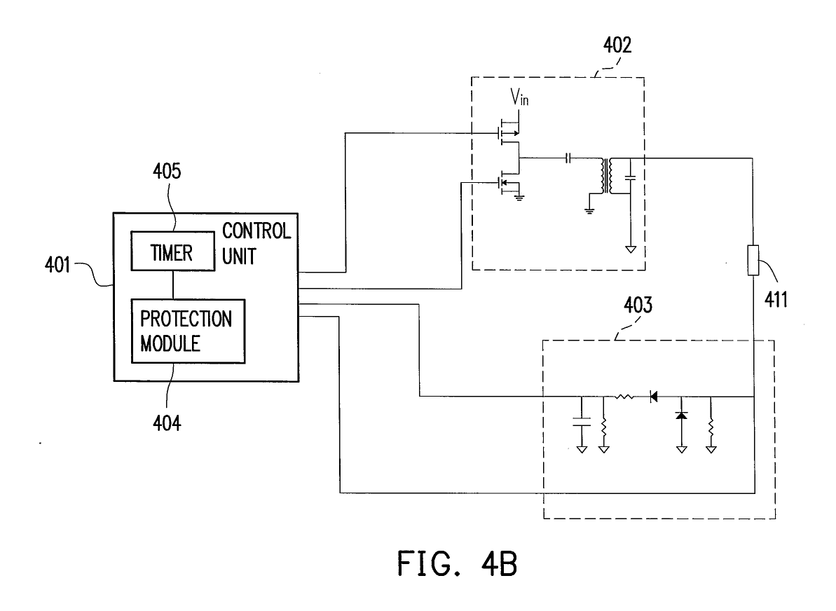

FIG. 4A is a block diagram of a driving circuit for a fluorescent lamp according to an exemplary embodiment of the present invention, and FIG. 4B is a circuit diagram of the driving circuit according to the exemplary embodiment of the present invention. Referring to FIG. 4A and FIG. 4B, in the present embodiment, the driving circuit includes a control unit 401, a power conversion unit 402, and a detection module 403. Besides, the control unit 401 includes a protection module 404 and a timer 405. In the present embodiment, the control unit 401 outputs a control signal, for example, a pulse width modulation (PWM) signal. The power conversion unit 402 receives the control signal from the control unit 401 and converts a power provided by a input voltage source Vin into a driving signal (for example, a voltage signal) according to the control signal for driving the fluorescent lamp 411.

The detection module 403 is coupled to the fluorescent lamp 411 for detecting the operating current of the fluorescent lamp 411, and the detection module 403 generates an operating parameter according to the operating current of the fluorescent lamp 411. The control unit 401 then adjusts the control signal according to the operating parameter so as to control the frequency of the driving signal output by the power conversion unit 402. When the timer 405 determines that a first predetermined time is achieved, the protection module 404 controls the power conversion unit 402 to output the driving signal normally or stop outputting the driving signal according to the operating parameter.

According to the driving circuit in the present embodiment, when the fluorescent lamp 411 is struck, the control unit 401 controls the power conversion unit 402 to generate a driving signal of high frequency, so as to provide a large driving voltage for driving the fluorescent lamp 411. Meanwhile, the control unit 401 also detects an operating parameter of the fluorescent lamp 411 through the detection module 403. Besides, the timer 405 in the control unit 401 generates a first counting value at the same time for counting the time of providing the driving signal to the fluorescent lamp 411. In the present embodiment, the timer 405 may use a time period for charging a capacitor to a predetermined voltage by using a current source as the predetermined time; however, the present invention is not limited thereto, and the timer 405 may be a well-known timer to those skilled in the art.

In the present embodiment, the operating parameter is a voltage generated while the operating current of the fluorescent lamp passes through a resistor. However, in other embodiments of the present invention, the control unit 401 may also detects the operating voltage of the fluorescent lamp 411 through the detection module 403 and uses the operating voltage as the operating parameter.

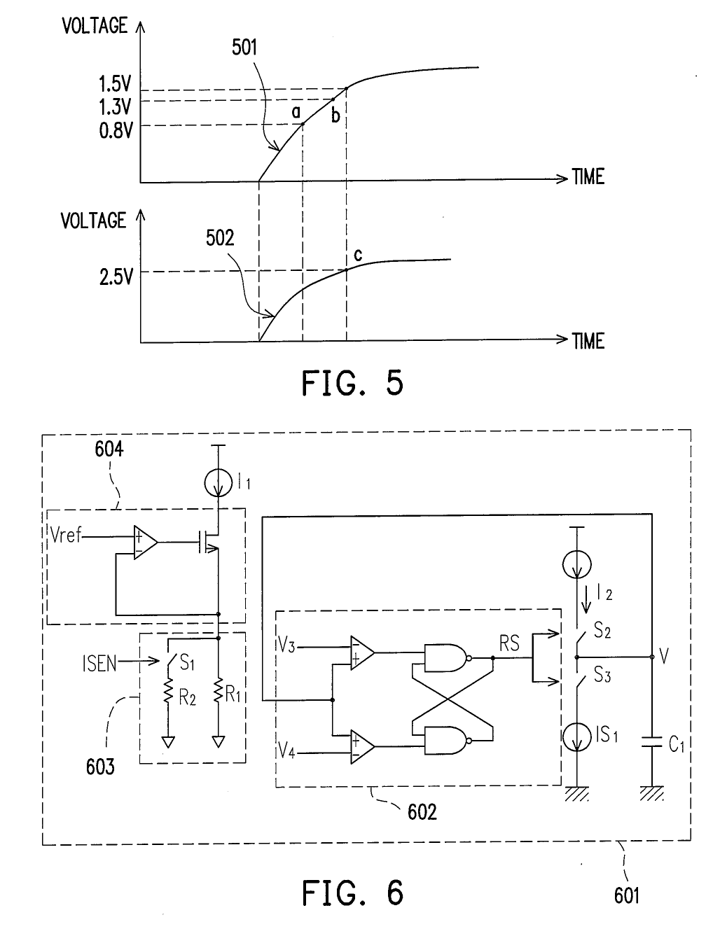

FIG. 5 is a timing diagram illustrating the operation of a driving circuit for a fluorescent lamp according to an exemplary embodiment of the present invention. Referring to both FIG. 4A and FIG. 5, curve 501 represents the operating parameter of the fluorescent lamp 411 detected by the detection module 403, and curve 502 illustrates the variation of a charging voltage of the timer 405 in the control unit 401 along time. When the control unit 401 detects that the operating parameter of the fluorescent lamp 411 achieves a first predetermined value a (for example, 0.8V) through the detection module 403, the control unit 401 lowers the frequency of the driving signal in order to control the power conversion unit 402 to provide proper operating voltage to the fluorescent lamp 411. Accordingly, the leakage current of the fluorescent lamp 411 is reduced.

Next, when the control unit 401 detects that the first counting value achieves a first predetermined counting value c (for example, charging the capacitor to 2.5V), the control unit 401 determines whether or not the detected operating parameter of the fluorescent lamp 411 is smaller than a second predetermined value b (for example, 1.3V). If the operating parameter is smaller than the second predetermined value, the protection module 404 in the control unit 401 controls the power conversion unit 402 to stop outputting the driving signal to the fluorescent lamp 411; otherwise if the operating parameter is greater than or equal to the second predetermined value, the protection module 404 in the control unit 401 controls the power conversion unit 402 to output the driving signal to the fluorescent lamp 411 as usual.

In another embodiment of the present invention, the control unit 401 further includes another timer (not shown). When the first counting value generated by the timer 405 achieves a first predetermined counting value and the operating parameter is smaller than a second predetermined value, the other timer starts to work, and if the operating parameter is still smaller than the second predetermined value after a second predetermined time, the protection module 404 controls the power conversion unit 402 to stop outputting the driving signal to the fluorescent lamp 411 in order to prevent incorrect operation caused by noise interference. In addition, in the present embodiment, if the operating parameter is greater than the second predetermined value within the second predetermined time, the other timer stops working and only re-starts when the operating parameter is again smaller than the second predetermined value. The other timer in the control unit 401 generates a second counting value, and it is determined that the second predetermined time has passed when the second counting value achieves a second predetermined counting value.

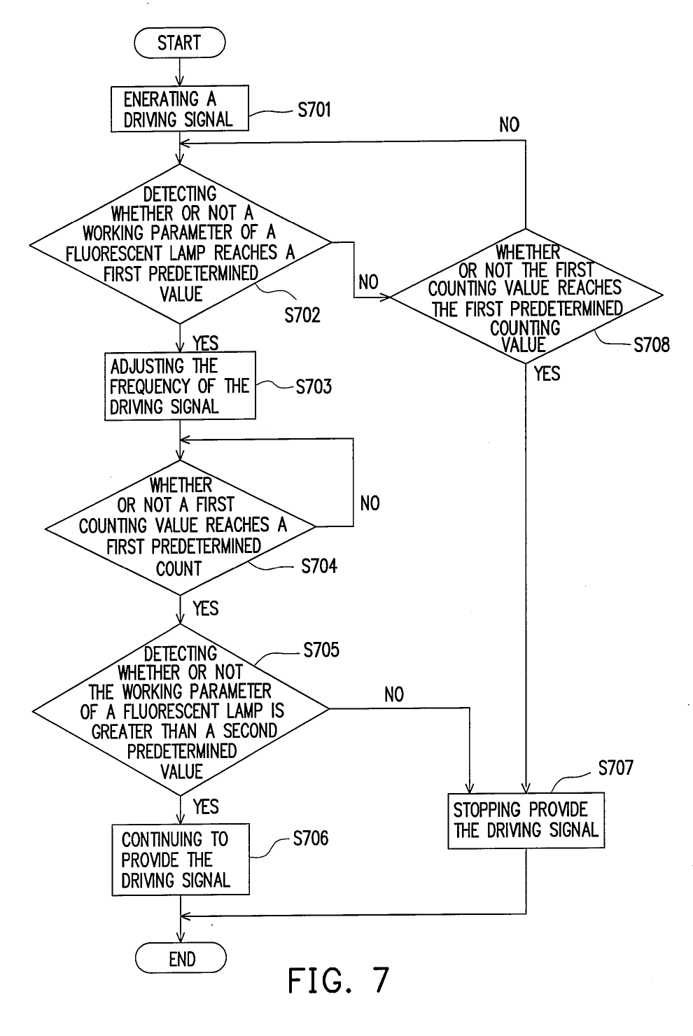

In the present embodiment, the control unit 401 includes a frequency conversion circuit for adjusting the frequency of the control signal and further for controlling the power conversion unit 402 to generate driving signals of different frequencies. FIG. 6 illustrates a frequency conversion circuit according to an exemplary embodiment of the present invention. Referring to both FIG. 4A, FIG. 4B, and FIG. 6, in the present embodiment, the frequency conversion circuit 601 includes two switches S₂ and S₃, a capacitor C₁, a flip-flop module 602, and a current control circuit 603. The capacitor C₁ is coupled to the switches S₂ and S₃ for generating a triangle wave signal (described below). The current control circuit 603 includes a switch S₁ and two resistors R₁ and R₂. One ends of the resistors R₁ and R₂ are both grounded, and the other end of the resistor R₂ is coupled to the other end of the resistor R₁ through the switch S₁ and receives a current signal I₁. In the present embodiment, the switch S₁ may be turned on/off according to a control signal ISEN, so as to accomplish the frequency conversion of the driving signal. The control signal ISEN is generated according to the operating parameter of the fluorescent lamp 411 detected by the detection module 403.

The switches S₂ and S₃ are connected to each other in series. In the present embodiment, the switches S₂ and S₃ actually perform opposite operations, namely, when the switch S₂ is turned on, the switch S₃ is turned off, and vice versa, wherein the switches S₂ and S₃ are turned on/off according to a control signal RS generated by the flip-flop module 602, so as to control the current signals I₂ and IS₁ to charge/discharge the capacitor C₁. Moreover, the current signals I₂ and I₁ affect each other. Generally speaking, the current signals I₁ and I₂ may be generated by a current mirror. In the present embodiment, the current signal I₂ is a mapped current of the current signal I₁; however, the present invention is not limited thereto. Besides, in some other selective embodiments of the present invention, the switches S₂ and S₃ may be implemented by using a PMOS transistor and a NMOS transistor.

Referring to FIG. 6 again, when the detection module 403 detects that the operating parameter of the fluorescent lamp 411 has not achieved a first predetermined value (such as a in FIG. 5), the switch S₁ is turned on. Here the resistors R₁ and R₂ are connected in parallel, so that the resistance of the current control circuit 603 is reduced and the current signal I₁ is increased. The current signal I₂ is also increased correspondingly due to the mapping of the current mirror. When the detection module 403 detects that the operating parameter of the fluorescent lamp 411 achieves the foregoing first predetermined value, the switch S₁ is turned off so that the resistance of the current control circuit 603 is increased and the current signal I₁ passing through the current control circuit 603 is decreased. Accordingly, the current signal I₂ is also reduced. Since the current signals I₂ and I₁ affect each other, in the present embodiment, an overvoltage protection circuit 604 is formed by an operational amplifier and a NMOS transistor for restricting the supply voltage of the current control circuit 603 to be within the scope of a reference voltage V_{ref}, so as to prevent overlarge current signal I₁.

The switch S₂ receives the current signal I₂ and determines whether or not to conduct the current signal I₂ to the capacitor C₁ to charge to the capacitor C₁ according to the control signal RS generated by the flip-flop module 602. The switch S₃ performs opposite operation as that of the switch S₂, which determines whether or not to discharge the capacitor C₁ through the current source IS₁ according to the control signal RS generated by the flip-flop module 602. A triangle wave signal is generated while charging/discharging the capacitor C₁. The flip-flop module 602 generates the control signal RS for controlling the switches S₂ and S₃ by using two comparison voltages V₃ and V₄ and the voltage level V of the capacitor C₁.

As described above, the switch S₁ is used for controlling the current signal I₂ and the switches S₂ and S₃ are used for charging/discharging the capacitor C₁, so as to generate triangle wave signals of different frequencies (a triangle wave signal of a first frequency is generated when the current signal I₂ is large, and a triangle wave signal of a second frequency is generated when the current signal I₂ is small, wherein the first frequency is higher than the second frequency). Besides, the control unit 401 compares the triangle wave signal and a reference voltage (for example, a DC voltage) to generate a PWM signal having the same frequency as the triangle wave signal, and the control unit 401 provides the PWM signal to the power conversion unit 402 so that the power conversion unit 402 generates the driving signal for driving the fluorescent lamp 411. As described above, driving signals of different frequencies for driving the fluorescent lamp 411 can be obtained through triangle wave signals of different frequencies.

Next, the operation of the flip-flop module 602 will be described in detail, and here it is assumed that in the flip-flop module 602, the reference voltage V₃ is higher than the reference voltage V₄. In other words, if the voltage level V of the capacitor C₁ is increased to the reference voltage V₃, the control signal RS generated by the flip-flop module 602 turns off the switch S₂ and turns on the switch S₃, so that charges in the capacitor C₁ are conducted to the current source IS₁ and accordingly the voltage level V of the capacitor C₁ is reduced. If the voltage level V of the capacitor C₁ is reduced to the reference voltage V₄, the control signal RS generated by the flip-flop module 602 turns on the switch S₂ and turns off the switch S₃, so that the mapped current signal I₂ is conducted to the capacitor C₁ and accordingly the voltage level V of the capacitor C₁ is increased. Accordingly the voltage of the triangle wave signal generated by the capacitor C₁ is controlled between V₃ and V₄.

FIG. 7 is a flowchart illustrating a driving method for a fluorescent lamp according to an exemplary embodiment of the present invention, and the driving method can be applied to the driving circuit illustrated in FIG. 4A. Referring to FIG. 7, in step S701, the driving circuit generates a driving signal for driving the fluorescent lamp 411, wherein the fluorescent lamp 411 is struck by increasing the frequency of the driving signal. Next, in step S702, whether or not an operating parameter of the fluorescent lamp 411 achieves a first predetermined value is detected. If the operating parameter has not achieved the first predetermined value, step S708 is executed, otherwise step S703 is executed.

In step S708, whether or not a first counting value has achieved a first predetermined counting value is determined, wherein the first counting value denotes the time elapsed for providing the driving signal constantly and which is obtained by the timer 405. If the first counting value has not achieved the first predetermined counting value, step S702 is executed, otherwise it is determined that the high-frequency driving signal has been provided to the fluorescent lamp 411 for a predetermined time and the operating parameter of the fluorescent lamp 411 has still not achieved the first predetermined value, thus, step S707 is executed to stop generating the driving signal, so as to protect the fluorescent lamp 411. In step S703, the frequency of the driving signal is adjusted, namely, the frequency of the driving signal is reduced so that an appropriate operating voltage is supplied to the fluorescent lamp 411.

After that, whether the first counting value has achieved the first predetermined counting value is determined in step S704. If the first counting value has not achieved the first predetermined counting value, step S704 is executed; otherwise if the first counting value has achieved the first predetermined counting value, step S705 is executed. In step S705, the operating parameter of the fluorescent lamp 411 is detected; if the operating parameter of the fluorescent lamp 411 is greater than the second predetermined value, which means the fluorescent lamp 411 has been struck successfully, the driving signal is provided to the fluorescent lamp 411 constantly in step S706 to allow the fluorescent lamp 411 to work properly; if the operating voltage of the fluorescent lamp 411 has not achieved the second predetermined value, which means the fluorescent lamp 411 cannot work properly (for example, the fluorescent lamp 411 is not struck), the driving signal is stopped being generated in step S707 so as to protect the fluorescent lamp 411. It should be noted here that in other embodiments of the present invention, step S707 further includes following steps. When the operating parameter is smaller than the second predetermined value, a second counting value is generated by another timer, and when the second counting value achieved a second predetermined counting value (i.e. a second predetermined time has elapsed) and the operating parameter is smaller than the second predetermined value, the driving signal is stopped being generated so that incorrect operation for protecting the fluorescent lamp caused by noise interference is prevented from being started up. Moreover, in the present embodiment, it is assumed that the other timer stops working when the operating parameter is greater than the second predetermined value within the second predetermined time, and the other timer only re-starts to time when the operating parameter is again smaller than the second predetermined value.

In summary, according to the present invention, the frequency of the driving signal is adjusted based on whether or not the operating parameter of the fluorescent lamp has achieved the first predetermined value. After a predetermined time, whether or not the operating parameter of the fluorescent lamp is smaller than the second predetermined value is detected again in order to check whether the fluorescent lamp is struck, so as to determine whether or not to stop generating the driving signal for protecting the fluorescent lamp. Moreover, according to another exemplary embodiment of the present invention, when the operating parameter is smaller than the second predetermined value, the driving signal is only stopped being generated when the operating parameter is still smaller than the second predetermined value after a second predetermined time, so as to prevent incorrect operation caused by noise interference.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for driving a fluorescent lamp, comprising:
generating a driving signal for driving the fluorescent lamp;
detecting an operating current of the fluorescent lamp;
adjusting the frequency of the driving signal when the operating current achieves a first predetermined value; and
detecting whether or not the operating current is smaller than a second predetermined value by which the driving signal is determined to be stopped or not, wherein the second predetermined value is greater than the first predetermined value.

2. The method as claimed in claim 1 further comprising:
generating a first counting value; and
detecting whether or not the operating current is smaller than the second predetermined value when the first counting value achieves a first predetermined counting value.

3. The method as claimed in claim 2 further comprising:
generating the driving signal when the operating current is greater than or equal to the second predetermined value; and
stopping generating the driving signal when the operating current is smaller than the second predetermined value.

4. The method as claimed in claim 3, wherein the step of stopping generating the driving signal when the operating current is smaller than the second predetermined value further comprises:
generating a second counting value; and L
stopping generating the driving signal when the second counting value achieves a second predetermined counting value and the operating current is smaller than the second predetermined value.

5. The method as claimed in claim 1, wherein the step of adjusting the frequency of the driving signal comprises reducing the frequency of the driving signal when the operating current achieves the first predetermined value.

6. A method for driving a fluorescent lamp, comprising:
generating a driving signal for driving the fluorescent lamp;
detecting an operating parameter of the fluorescent lamp;
adjusting the frequency of the driving signal when the operating parameter achieves a first predetermined value; and
determining whether or not the operating parameter is smaller than a second predetermined value after a predetermined time, wherein the driving signal is stopped being generated when the operating parameter is smaller than the second predetermined value, and the driving signal is continued to be generated when the operating parameter is greater than or equal to the second predetermined value.

7. The method as claimed in claim 6, wherein the operating parameter is an operating current signal.

8. The driving method as claimed in claim 6, wherein the step of determining whether or not the operating parameter is smaller than the second predetermined value after the predetermined time further comprises:
generating a first counting value; and
determining whether or not the operating parameter is smaller than the second predetermined value when the first counting value achieves a first predetermined counting value indicating that the predetermined time has passed.

9. The method as claimed in claim 8, wherein the step of stopping generating the driving signal when the operating parameter is smaller than the second predetermined F value further comprises:
generating a second counting value; and
stopping generating the driving signal when the second counting value achieves a second predetermined counting value and the operating parameter is smaller than the second predetermined value.

10. The driving method as claimed in claim 6, wherein the frequency of the driving signal is reduced when the operating parameter achieves the first predetermined value.

11. The method as claimed in claim 6, wherein the fluorescent lamp is a CCFL.

12. The driving method as claimed in claim 6, wherein the driving signal is a PWM signal having a first frequency when the operating parameter has not achieved the first predetermined value while the driving signal is a PWM signal having a second frequency when the operating parameter achieves the first predetermined value, wherein the first frequency is higher than the second frequency.

13. A circuit for driving a fluorescent lamp, comprising:
a power conversion unit, for generating a driving signal for driving the fluorescent lamp;
a detection module, for detecting a operating parameter of the fluorescent lamp; and
a control unit, controlling the power conversion unit to drive the fluorescent lamp and receiving the operating parameter, when the operating parameter achieves a first predetermined value, the control unit adjusting the frequency of the driving signal, and the control unit determining whether or not the operating parameter is smaller than a second predetermined value after a first predetermined time, when the operating parameter is smaller than the second predetermined value after the first predetermined time, the control unit controlling the power conversion unit to stop generating the driving signal.

14. The circuit as claimed in claim 13, wherein the operating parameter is an operating current of the fluorescent lamp.

15. The circuit as claimed in claim 13, wherein the control unit has a first timer for determining whether or not the first predetermined time has passed.

16. The circuit as claimed in claim 15, wherein the control unit further comprises a second timer, and the control unit stops generating the driving signal when the operating parameter is smaller than the second predetermined value after a second predetermined time, wherein the second timer is used for determining whether or not the second predetermined time has passed.

17. The circuit as claimed in claim 13, wherein the control unit comprises a frequency conversion circuit for adjusting the frequency of the driving signal.

18. The circuit as claimed in claim 17, wherein the frequency conversion circuit comprises:
a current mirror, for generating a first current signal and a second current signal, wherein the second current signal is a mapped current of the first current signal;
a first switch, receiving the first current signal, and the first switch is determined to be turned on or turned off according to a first control signal so as to adjust the first current signal;
a second switch, coupled to the current mirror, and the second switch is determined to be turned on or turned off according to a second control signal;
a capacitor, coupled to the second switch, the capacitor receiving the second current signal via the second switch when the second switch is turned on;
a third switch, performing opposite operation of the second switch, for determining whether or not to conduct charges in the capacitor to a current source according to the second control signal;
a flip-flop module, generating the second control signal according to a first reference voltage, a second reference voltage, and a supply voltage of the capacitor.
wherein the first control signal is generated according to the operating parameter of the fluorescent lamp, and the capacitor generates a triangle wave signal having a first frequency or a second frequency based on whether or not the first switch and the second switch are turned on/off.

19. The circuit as claimed in claim 18, wherein the control unit generates a PWM signal having the first frequency or the second frequency according to the triangle wave signal having the first frequency or the second frequency, wherein the first frequency is higher than the second frequency.

20. The circuit as claimed in claim 18, wherein the flip-flop module comprises:
a first operational amplifier, having a inverting input terminal receiving the first reference voltage and a non-inverting input terminal receiving the supply voltage of the capacitor, the first operational amplifier generating a first output signal;
a second operational amplifier, having a inverting input terminal receiving the second reference voltage and a non-inverting input terminal receiving the supply voltage of the capacitor, the second operational amplifier generating a second output signal;
a first NAND gate, receiving the first output signal and a third output signal to generate the second control signal; and
a second NAND gate, receiving the second output signal and the second control signal to generate the third output signal.
